(19) United States
(12) Patent Application Publication
(10) Pub. No.: US 2026/0216817 A1
(43) Pub. Date: Jul. 30, 2026

(54) SMALL-SCALE SOLID-STATE ADDITIVE MANUFACTURING TOOLS AND DESIGNS

(71) Applicant: VIRGINIA TECH INTELLECTUAL PROPERTIES, Blacksburg, VA (US)

(72) Inventors: Ryan GOTTWALD, Morrisville, NC (US); Hang Z. YU, Blacksburg, VA (US)

(21) Appl. No.: 19/145,847

(22) PCT Filed: Jan. 2, 2024
(86) PCT No.: PCT/US2024/010061

§ 371 Date: Jul. 3, 2025

Related U.S. Application Data
(60) Provisional application No. 63/436,799, filed on Jan. 3, 2023.

(51) Int. Cl. B23K 20/12; B33Y 30/00; B33Y 50/02

(52) U.S. Cl. CPC B23K 20/1215; B23K 20/123; B23K 20/125; B33Y 30/00; B33Y 50/02

(57) ABSTRACT

An apparatus may include a modular tool positioned in a spaced apart relationship with a rotatable head holding a feed rod for additive manufacturing, the modular tool comprising: a first portion having a first aperture that slidably allows the feed rod to pass through, a second portion coupled with the first portion, the second portion having a second aperture aligned with the first aperture, the second aperture slidably allows the feed rod to pass through, the second portion having a melting point that is less than the melting point of the first portion, a bearing coupled with at least one of the first portion or the second portion.

### CROSS-REFERENCE TO RELATED APPLICATIONS

This application claims priority to U.S. Provisional Patent Application No. 63/436,799, filed Jan. 3, 2023, entitled “Small-Scale Solid-State Additive Manufacturing Tools and Designs,” the entirety of which is incorporated by reference herein.

### TECHNICAL FIELD

This disclosure relates to the additive manufacturing, and in particular to tools and designs for use in additive manufacturing.

### DESCRIPTION OF THE RELATED TECHNOLOGY

Additive friction stir deposition (AFSD) is an additive manufacturing technique where the material is deformed beneath a rotating tool head under high pressure and temperature. A feed rod made of the desired deposition material is rotated and pushed down on a substrate. The portion of the feed rod making contact with the substrate and the substrate itself heat up due to friction therebetween. When the temperature reaches a threshold value, the force pushing the feed rod exceeds the yield strength of the material thereby causing the material to deform beneath the tool. The feed rod can be moved laterally over a desired path on the substrate to deposit the material.

### SUMMARY

In some aspects, the techniques described herein relate to an apparatus for additive manufacturing, including: a modular tool positioned in a spaced apart relationship with a rotatable head holding a feed rod for additive manufacturing, the modular tool including: a first portion having a first aperture that slidably allows the feed rod to pass through, a second portion coupled with the first portion, the second portion having a second aperture aligned with the first aperture, the second aperture slidably allows the feed rod to pass through, the second portion having a melting point that is less than the melting point of the first portion, a bearing coupled with at least one of the first portion or the second portion.

In some aspects, the techniques described herein relate to an apparatus, wherein the second portion includes a recess, and wherein the first portion is press fit into the recess.

In some aspects, the techniques described herein relate to an apparatus, wherein the second portion includes a recess and at least a portion of sidewalls of the recess are threaded, wherein at least a portion of an outer surface of the first portion is threaded, wherein the first portion is screwed into the recess.

In some aspects, the techniques described herein relate to an apparatus, wherein the first portion is coupled with the second portion by clamps.

In some aspects, the techniques described herein relate to an apparatus, further including a thermal barrier layer disposed between the first portion and the second portion.

In some aspects, the techniques described herein relate to an apparatus, wherein the first portion is made of at least one refractory metal.

In some aspects, the techniques described herein relate to an apparatus, wherein the first portion includes tungsten and rhenium.

In some aspects, the techniques described herein relate to an apparatus, wherein the first aperture and the second aperture are sized such that rotation of the feed rod imparts rotational force to sidewalls of the first aperture and the second aperture.

In some aspects, the techniques described herein relate to an apparatus, wherein the second portion includes a first member and a shoulder member wider than the first member, wherein the bearing is coupled with the first member, and wherein the first portion is coupled with the shoulder member of the second portion.

In some aspects, the techniques described herein relate to an apparatus, wherein the second portion includes leaded steel.

In some aspects, the techniques described herein relate to an apparatus, further including: a feed mechanism coupled with the rotatable head, the feed mechanism configured to move the rotatable head in relation to the modular tool.

In some aspects, the techniques described herein relate to an apparatus, wherein the feed mechanism includes: a motor coupled with the feed mechanism, the movement of the motor causing the feed mechanism to move the rotatable head in relation to the modular tool, a force-sensor for sensing a force with which the feed rod extending out of the modular tool is pressed against a substrate positioned below the modular tool.

In some aspects, the techniques described herein relate to an apparatus, wherein the feed rod has a rectangular cross-section, and wherein dimensions of a side of the rectangular cross-section are no more than 0.125 inches.

In some aspects, the techniques described herein relate to an apparatus, wherein the feed rod has an average diameter of no more than 0.18 inches.

In some aspects, the techniques described herein relate to an apparatus, further including a heat source positioned below the substrate.

In some aspects, the techniques described herein relate to an apparatus, further including: a platform for moving the modular tool and the rotatable head in an x-y plane using a x-axis motor coupled with a x-axis driver and a y-axis motor coupled with a y-axis driver; a feed-axis driver coupled with the motor, which in turn is coupled with the feed mechanism; and a controller coupled with the x-axis driver, the y-axis driver, and the feed-axis driver, configured to: receive a desired feed rod position in the x-y plane, communicate with the x-axis driver and the y-axis driver to move the modular tool and the rotatable head such that a tip of the feed rod is positioned at the desired feed-rod position, receive force information from a force sensor, and communicate with the feed-axis driver to apply a constant downward force to the feed rod of a desired magnitude prior to yielding of feed-rod material.

In some aspects, the techniques described herein relate to an apparatus, wherein the controller is configured to: receive temperature information from a temperature sensor sensing temperature at or around an interface between the tip of the feed-rod and the substrate, and communicating with at least one of the rotatable head and the feed-axis driver based on the received temperature and a desired temperature.

In some aspects, the techniques described herein relate to an apparatus, wherein the controller is configured to: communicate with the x-axis driver and the y-axis driver to move the modular tool and the rotatable head such that the tip of the feed rod is positioned at the desired feed-rod position only after the received temperature is at the desired temperature.

In some aspects, the techniques described herein relate to an apparatus, wherein the controller is configured to: communicate with the feed-axis driver to increase a downward force to the feed rod, and communicate with the x-axis driver and the y-axis driver to move the modular tool and the rotatable head over a predetermined path on the substrate.

### BRIEF DESCRIPTION OF THE DRAWINGS

FIG. 1 shows an apparatus for additive manufacturing.

FIG. 2 shows multiple views of a modular tool discussed above in relation to FIG. 1.

FIG. 3 shows a system for controlling the operation of the apparatus discussed above in relation to FIGS. 1 and 2.

FIG. 4 shows example graphs of temperature and force during the operation of the apparatus discussed above in relation to FIGS. 1-3.

Like reference numbers and designations in the various drawings indicate like elements.

### DETAILED DESCRIPTION

The various concepts introduced above and discussed in greater detail below may be implemented in any of numerous ways, as the described concepts are not limited to any particular manner of implementation. Examples of specific implementations and applications are provided primarily for illustrative purposes.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Prior to describing the various aspects of the present disclosure, the following definitions are provided and should be used unless otherwise indicated. Additional terms may be defined elsewhere in the present disclosure.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used in the specification and the appended claims, the singular forms “a,” “an” and “the” include plural referents unless the context clearly dictates otherwise. Thus, for example, reference to “a proton beam degrader,” “a degrader foil,” or “a conduit,” includes, but is not limited to, two or more such proton beam degraders, degrader foils, or conduits, and the like.

The various concepts introduced above and discussed in greater detail below may be implemented in any of numerous ways, as the described concepts are not limited to any particular manner of implementation. Examples of specific implementations and applications are provided primarily for illustrative purposes.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e., one atmosphere).

Solid state additive manufacturing such as, for example, additive friction stir deposition (AFSD) involves rotating a feed rod over a substrate to cause deposition of the material from the feed rod onto the substrate. The feed rod is rotated while in contact with the substrate. The friction between the bottom of the feed rod and the substrate causes the temperature of the bottom of the feed rod as well as the contact surface of the substrate to rise. At a certain temperature, the material of the feed rod begins to yield and extrudes to fill the space between the substrate and the rotating feed rod. The width of the deposited material can be a function of the thickness of the feed rod. Traditional feed rod widths range from ⅜th inches and higher. This typically results in deposition widths of about one inch. One approach to achieving narrower widths is to employ narrower feed rods. However, narrower feed rods for the same rotations-per-minute (rpm) as for wider ⅜th inch rods would generate less heat. The lack of heat may reduce the effectiveness of the deposition of the material onto the substrate. The feed rod could be rotated at a higher rpm to increase the temperature. However, rotating at a higher rpm can increase the risk of smearing of the material deposited on the substrate, thereby reducing the quality or strength of the deposition.

One approach to alleviating the lack of heat at the contact between the feed rod and the substrate, as discussed herein, is to reduce the amount of heat that dissipates away from the contact. In particular, a modular tool can be employed that is positioned in close proximity with the contact point between the feed rod and the substrate. At least a portion of the modular tool can create a thermal barrier to the heat dissipated at the contact between the feed rod and the substrate. The reduction in the heat dissipation can in turn help maintain the contact between the feed rod and the substrate at higher temperatures. Thus, the desired temperature at the contact between the feed rod and the substrate can be achieved with relatively lower rpms of the feed rod, thereby reducing the risk of smearing. Thus, depositions with smaller widths can be achieved without reducing the quality or strength of the deposition. As a result, narrower feed rods can be employed for the deposition. Narrower feed rods also have the advantage of requiring relatively lower force onto the substrate for effective deposition. Thus, relatively smaller machines can be utilized for additive manufacturing, which smaller machines can enable the manufacturing setup to be mobile.

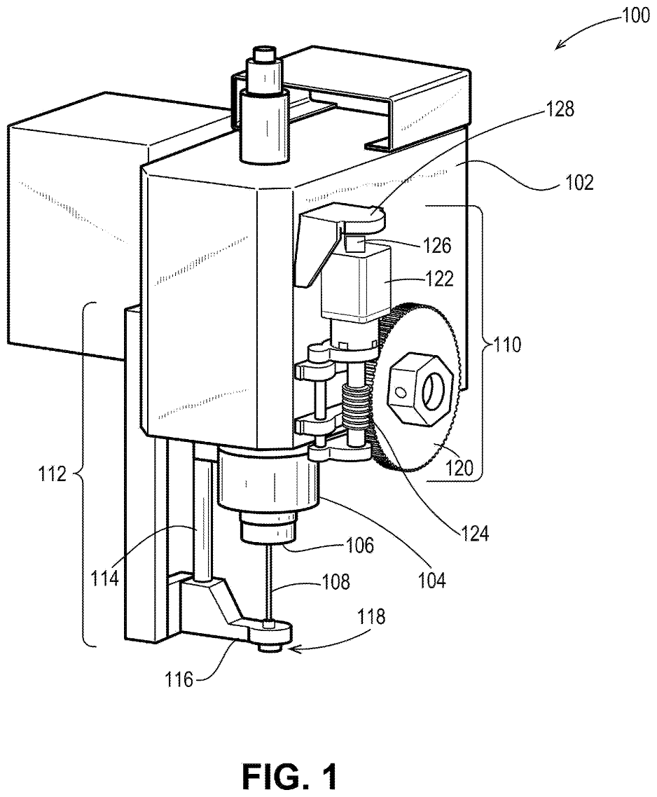

FIG. 1 shows an apparatus 100 for additive manufacturing. In particular, apparatus 100 includes a tool head 102, a rotatable head 104, a collet holder 106, a feed rod 108, a feed mechanism 110, a tool support structure 112, a vertical track 114, a modular tool support 116, and a modular tool 118. The apparatus 100 can be similar to a milling machine or a computer numerical control (CNC) machine. The tool head 102 can house a motor for providing rotational force to the rotatable head 104 as well as mechanism for vertical movement of the rotatable head 104. The rotatable head 104 can be positioned at the bottom of the tool head 102 facing the modular tool 118. The rotatable head 104 can include a collet holder 106 that firmly holds the feed rod 108. The modular tool 118 is positioned on the modular tool support 116 such that an aperture in the modular tool 118 is aligned with the collet holder 106 such that the feed rod 108 can extend between the collet holder 106 and the modular tool 118. The modular tool support 116 can position the modular tool 118 below the collet holder 106. The modular tool support 116 can extend between the tool support structure 112 and the modular tool 118. The modular tool support 116 can include an aperture into which the modular tool 118 can be positioned. The modular tool 118 can include a bearing, an outer portion of which can be coupled with the tool support structure 112 and an inner portion of which is coupled with the modular tool 118. This allows the feed rod 108, which passes through the modular tool 118, to impart rotational motion to the modular tool 118.

A vertical track 114 can extend between the tool head 102 and the modular tool support 116. The vertical track 114 can be coupled with the rotatable head 104 and provide a guide for the vertical movement of the rotatable head 104. The rotatable head 104 can be coupled with the feed mechanism 110, which includes a rotary gear 120, a drive motor 122, and a worm gear 124. The rotary gear 120 rotates around a shaft that extends internally into the tool head 102 and couples with a mechanism that translates the rotary motion of the shaft into a linear motion of the rotatable head 104. The teeth of the rotary gear 120 are coupled with the teeth of the worm gear 124. A shaft of the worm gear 124 is coupled with the shaft of the drive motor 122. The drive motor 122 can be communicably coupled with a user interface that allows the user to switch the drive motor 122 on or off as well as control the motor rpm. During operation, the drive motor 122 turns the worm gear 124, which, in turn, turns the rotary gear 120. Turning of the rotary gear 120 causes the mechanism within the tool head 102 to translate the rotary motion of the shaft of the rotary gear 120 into linear motion of the rotatable head 104 in relation to the modular tool 118. When the drive motor 122 rotates in one direction, the rotatable head 104 can be moved towards the modular tool 118, while the rotation of the drive motor 122 in the opposite direction can move the rotatable head 104 away from the modular tool 118. The downward movement of the rotatable head 104 can cause the feed rod 108 to be pushed downward on the substrate. The downward force in combination with the rotational force on the feed rod 108 can cause deposition of the material of the feed rod 108 onto the substrate.

A force sensor can be positioned between the feed mechanism 110 and a mount that couples the feed mechanism 110 to the tool head 102. As an example, a force sensor 126 can be positioned between the drive motor 122 and a motor mount 128. The force sensor 126 can sense the force with which the feed rod 108 is pushed down on the substrate. The force with which the feed rod 108 is pushed down on the substrate can affect the temperature at the contact between the feed rod 108 and the substrate. The force sensor 126 can be used to sense the magnitude of the force. In some implementations, a controller can control the drive motor 122 based on the force measurement provided by the force sensor 126 to achieve the desired magnitude of force with which the feed rod 108 is pushed down onto the substrate.

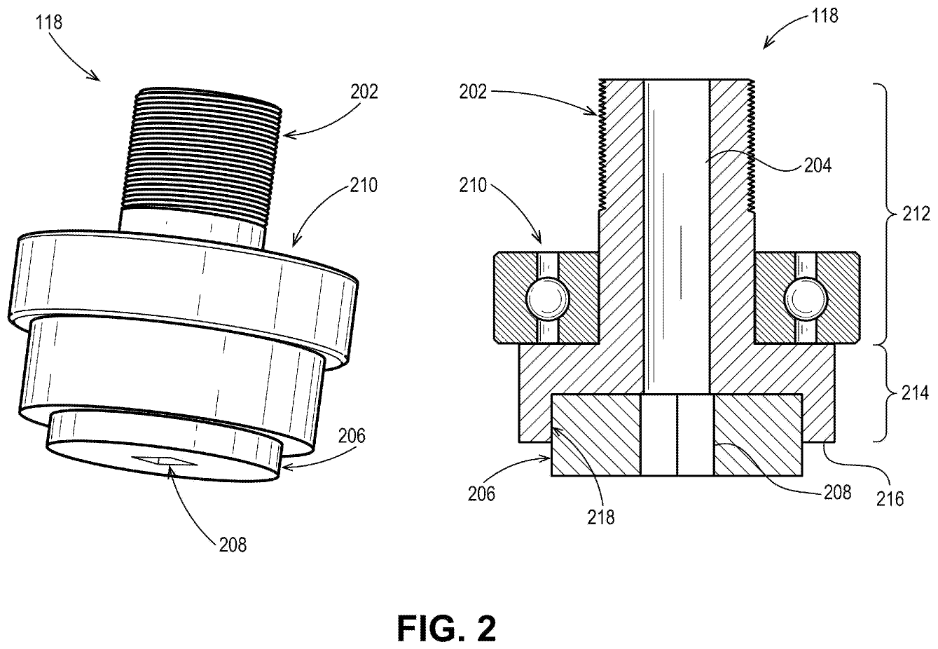

FIG. 2 shows multiple views of the modular tool 118 discussed above in relation to FIG. 1. In particular, FIG. 2, on the left shows a side view of the modular tool 118 and on the right shows a cross-sectional view of the modular tool 118. As mentioned in relation to FIG. 1, the modular tool 118 is positioned in a spaced apart relationship with the rotatable head 104. The modular tool 118 includes a first portion 206 having a first aperture 208 and a second portion 202 having a second aperture 204. The second portion 202 is coupled with the first portion 206 and the first aperture 208 is aligned with the second aperture 204 such that the feed rod 108 can slidably pass through both the first aperture 208 and the second aperture 204. During operation of the apparatus 100, the rotatable head 104 pushes the feed rod 108 into the second aperture 204 and out the first aperture 208. The modular tool 118 further includes a bearing 210 coupled with the second portion 202. In some instances, the bearing 210 can also be coupled with the first portion 206 or both the first portion 206 and the second portion 202. The bearing 210 can have an outer ring that is coupled with or affixed to the modular tool support 116 (FIG. 1).

The second portion 202 can include a first member 212 and a shoulder member 214. The width of the shoulder member 214 can be greater than the width of the first member 212. The shoulder member 214 can be viewed as a flange, which abuts at least a portion of the bearing 210. The diameter of the first member 212 can be selected such that the inner ring of the bearing 210 can be securely held by friction on the outer surface of the first member 212. In some other instances, the bearing 210 can be secured to the modular tool 118 using fasteners. The first aperture 208 is coupled with the shoulder member 214 of the modular tool 118. In particular, the shoulder member 214 can include a bottom surface 216 that defines a recess 218 which receives the first portion 206. The first portion 206 is press fit with the shoulder member 214 of the modular tool 118. In some examples, at least a portion of the sidewalls of the recess 218 can be threaded and at least a portion of an outer surface of the first portion 206 can be threaded to complement the threads on the sidewalls of the recess 218. In such instances, the first portion 206 can screwed into the recess 218. In some examples, the first portion 206 can be coupled with the second portion 202 by clamps. In some other examples, other fasteners such as screws, bolts, adhesives, alone or in combination can be employed to couple the first portion 206 with the second portion 202.

The first aperture 208 and the second aperture 204 can be of the same cross-sectional dimensions. In some instances, the cross-sectional shape of the first aperture 208 and the second aperture 204 can be the same as the cross-sectional shape of the feed rod 108. The inner dimensions of the first aperture 208 and the second aperture 204 can be selected such that the feed rod 108 can slide linearly through the apertures (i.e., along the length of the apertures). However, when the feed rod 108 is rotated, the feed rod 108 imparts rotational force to the sidewalls of the at least one of the first aperture 208 or the second aperture 204, thereby causing the first portion 206 and the second portion 202 to rotate with the feed rod 108. In some examples, the cross-sectional shape of the second aperture 204 can be different from the cross-sectional shape of the first aperture 208. For example, the second aperture 204 can have a circular cross-sectional shape where the diameter of the cross-section can be slightly greater (e.g., 1%-5%) greater than the largest cross-sectional dimension (e.g., the cross-sectional diagonal) of the feed rod 108. In such instances, the feed rod 108 largely imparts rotational force to the sidewalls of the first aperture 208 of the first portion 206. In some instance, the cross-sectional shape of the first aperture 208 can be circular while the cross-sectional shape of the second aperture 204 can be the same as that of the feed rod 108, and the feed rod 108 largely imparts rotational force to the sidewalls of the second aperture 204. Of course, because the second portion 202 and the first portion 206 are coupled with each other, rotational force imparted to either of these portions will cause the rotation of the entire modular tool 118. In some instances, the feed rod 108 can have a substantially a rectangular shape with each side having an approximate length of no more than about ⅛th of an inch or about 0.125 inches. This allows formation of narrower tracks of deposition. In some instances, the feed rod 108 can have a rectangular shape or other shapes and can have an average diameter of no more than 0.177 inches.

The melting point of the second portion 202 can be less than the melting point of the first portion 206. Further, the melting point of the second portion 202 can be greater than the melting point of the material of the feed rod 108. The first portion 206, which is positioned in close proximity with the contact point of the feed rod 108 and the substrate should be designed to be able to withstand the temperature at the contact point. Some traditional approaches build the entire modular tool 118 with a monolithic block of material having a melting point greater than the melting point of the feed rod 108. However, in most instances, the material used to form the monolithic block can have high costs. By using a modular approach, the modular tool 118 discussed herein uses the high cost material to form only a portion of the modular tool 118, thereby reducing costs. The modular approach also helps in reducing the dissipation of heat from the contact area of the feed rod 108 and the substrate. For example, using different material that have different thermal properties provides a thermal barrier to the heat dissipated through the modular tool 118. In particular, using the higher temperature material for the first portion 206 and a relatively lower temperature material for the second portion 202 can create a thermal barrier at the interface between the first portion 206 and the second portion 202. As a result, dissipation of the heat generated at the contact point between the feed rod 108 and the substrate is reduced. Reducing the heat dissipation from the contact point advantageously allows the temperature at the contact point to be relatively higher, which, in turn, results in more effective deposition of the material from the feed rod 108 onto the substrate.

In some examples, the first portion 206 can include at least one refractory metal. For example, the first portion 206 can include an alloy formed of 75% tungsten and 25% rhenium. Other refractory metals with different proportions could also be used. In some examples, materials such as ceramic could also be used. For instance, materials such as cubic boron nitride could also be used. In some examples, the second portion 202 can include metals such as, for example, steel, leaded steel, etc.

In some examples, a thermal barrier can be positioned at the interface of the first portion 206 and the second portion 202 to further reduce the dissipation of heat generated at the contact point between the feed rod 108 and the substrate. The thermal barrier can be an high temperature insulator positioned between the first portion 206 and the first aperture 208. Materials such as, for example, ceramics or other high temperature metals (i.e., metals with melting point greater than that of the material of the feed rod 108) could also be used.

In some instances, a temperature sensor can be positioned on the first portion 206 to measure an approximate temperature at the contact point of the feed rod 108 and the substrate. For example, a surface of first portion 206 that faces the substrate can define a recess for housing the temperature sensor. A controller can receive the temperature values from the temperature sensor and can adjust the rotational speed of the feed rod 108 or the force with which the feed rod 108 is pressed down onto the substrate to ensure that the temperature at the contact point is maintained with the desired range.

In some examples, a heat source can be positioned below the substrate. The heat source can provide heating in addition to the heat generated by the friction between the tip of the feed rod 108 and a surface of the substrate that is in contact with the tip of the feed rod 108. It should be noted that the top surface of the substrate can refer to the uppermost surface with which the feed rod 108 makes contact during deposition. That top surface can be an uppermost layer of the deposited material or any other surface such as, for example, the top surface of the substrate which is yet to be covered with the material from the feed rod 108. The heat source can raise the temperature at the contact between the tip of the feed rod 108 and the top surface of the substrate to the desired temperature that facilitates the deposition of the material from the feed rod 108 onto the top surface of the substrate. In some instances, the presence of the heat source can allow the rpm of the feed rod 108 to be lower than that needed without the heat source. As a result, the risk of sputtering of the deposited material associated with high rpms can be reduced.

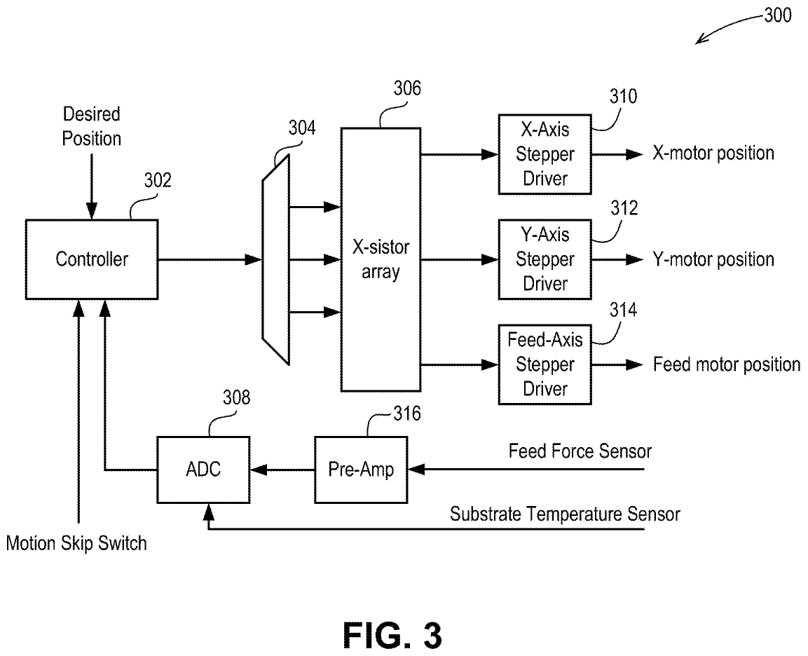

FIG. 3 shows a system 300 for controlling the operation of the apparatus 100 discussed above in relation to FIGS. 1 and 2. In particular, the system 300 includes a controller 302, a demultiplexer 304, a transistor array 306, an x-axis driver 310, a y-axis driver 312, a feed-axis driver 314, a pre-amplifier 316, and an analog-to-digital controller ADC 308. The apparatus 100 can include a platform (not shown) for moving at least the modular tool 118 and the rotatable head 104 in an xy-plane using an x-axis motor coupled with the x-axis driver 310 and a y-axis motor coupled with the y-axis driver 312. In some examples, the platform can move the entire assembly of the tool head 102 and the modular tool support 116 including the modular tool 118 in relation to a substrate. The movement of the modular tool 118 in relation to the substrate moves the tip of the feed rod 108 in relation to the substrate allowing the user to traverse a desired path on the substrate to deposit and form items of desired shape and size.

The controller 302 can include digital and digital/analog microcontrollers, PLCs, microprocessors, logic controllers, etc. The controller 302 can communicate positional data and/or instructions to each of the x-axis driver 310, the y-axis driver 312 and the feed-axis driver 314. In some instances, such as shown in FIG. 3, a demultiplexer 304 and a transistor array 306 can be utilized as an interface between the controller 302 and the drivers. The controller 302 can control the demultiplexer 304 to select the driver to which the output of the controller 302 is fed. The transistor array 306 can include an array of transistor switches that when selectively switched on/off can provide the desired voltage/current to the drivers corresponding to the output of the controller 302. The feed-axis driver 314 can be coupled with a motor that controls the vertical motion of the feed rod 108. For example, the feed-axis driver 314 can be coupled with the drive motor 122 shown in FIG. 1. The controller 302 can receive inputs from a feed force sensor (e.g., the force sensor 126 shown in FIG. 1), and a substrate temperature sensor that provides temperature at or around an interface between the tip of the feed rod 108 and the substrate. In some implementations, the signals from the feed force sensor and the temperature sensor can be converted into digital form by the ADC 308. In some instances, the signals may be amplified by the pre-amplifier 316 prior to digitization. The controller 302 also can receive a signal from a motion skip switch, which when received, causes the controller 302 to cancel a slow feed-rod dwell during heat generation when current heat generation is sufficient to enable material deposition.

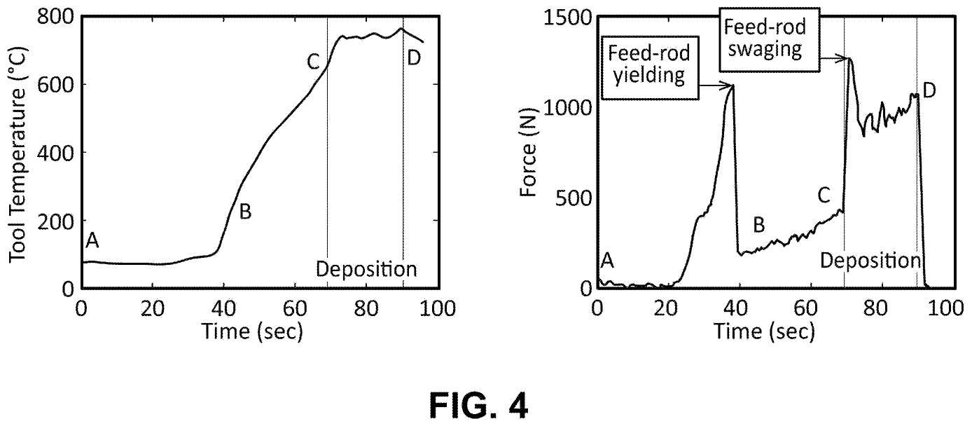

FIG. 4 shows example graphs of temperature and force during the operation of the apparatus 100. In particular, the graph on the left shows the temperature over time at various stages of operation during deposition of a single track of AISI 4140 steel onto an AISI 1018 substrate, and the graph to the right shows the force with which the feed rod is pushed down on the substrate for the deposition of the single track. While FIG. 4 shows the graphs for the deposition of specific materials, the graphs can generally represent deposition of other materials as well. First, the controller 302 can communicate with the tool head 102 to being spinning the feed rod 108 at a desired rpm. In some examples, the rotation of the feed rod 108 can be between about 3500 to about 1500 rpm, or about 2500 rpm. However, other rotation speeds could be used based in part on the material of the feed rod 108. The controller 302 can communicate with the feed-axis driver 314 to control the drive motor 122 to push the rotatable head 104 downward, causing the rotating feed rod 108 to press down on the substrate. The controller 302 can configure the drive motor 122 such that the feed rod 108 is pushed down at a desired rate (also referred to as a feed-rate) such as, for example, a few millimeters per minute. In some examples, the controller 302 can control the drive motor 122 to provide a feed-rate of about 2 mm/min to about 8 mm/min, or a feed-rate of about 5 mm/min.

The controller 302 can maintain the feed rod 108 stationary in the x-y plane, i.e., the controller 302 can control the 108 without any traversal in the x-y plane. The rotation of the feed rod 108 while in contact with the substrate can result in an increase in the temperature of the interface between the feed rod 108 and the substrate. As shown in the graph to the left in FIG. 4, the temperature rises at the contact point between the feed rod 108 and the substrate. At a certain point, for example at time indicated with letter “B”, the temperature of the contact point between the feed rod 108 and the substrate increases sufficiently to cause the material of the feed rod 108 to yield. The softening of the material of the feed rod 108 at the contact point with the substrate can result in a reduction in force, as indicated by the graph to the right in FIG. 4. The controller 302 can continue to rotate the feed rod 108 at the constant feed-rate until a certain temperature is reached. For example, referring to the left graph in FIG. 4, the controller 302 can continue to rotate the feed rod 108 at the constant feed-rate until a temperature indicated by the letter “C” is reached (e.g., 650° C.). At this time, the controller 302 can begin traversal of the tip of the feed rod 108 in the x-y plane. In some instances, the controller 302, during traversal of the feed rod 108, can increase the feed-rate of the feed rod 108. As an example, the controller 302 can increase the feed-rate to about 30 mm/min to about 50 mm/min or increase it to about 40 mm/min. This can cause a further increase in the temperature of the interface between the feed rod 108 and the substrate as well as an increase in the force. As an example, the temperature can rise to about 800° C. The increase in feed-rate during traversal can also increase the force with which the feed rod 108 is pushed down on the substrate, in part, due to swaging. As the feed rod 108 is pushed faster, it swells inside the modular tool 118 and adopts the interior shape of the first aperture 208. This increases the friction on the inner walls, which can be overcome by the compression force via the feeding mechanism and the deposition can continue without jamming. After swaging, the force can drop slightly and can be maintained at a relatively stable level during steady-state deposition. Once deposition is complete at point D, the feed rod 108 breaks from the deposition track, the compression force drops substantially to zero, and the temperature at the tip of the feed rod 108 drops with natural cooling.

With the example 4140 steel deposition, the deposited material shows a significant increase in hardness from 327.1±11.0 HV to 646.6±15.7 HV. The increase in hardness can be related to the grain size refinement from the initial feed rod to the deposited material. The decrease in the martensitic lathe size and thus increased grain boundary area increases the hardness following Hall-Petch strengthening. The substrate microstructure can remain relatively unchanged during deposition due to low temperatures experienced by the substrate during deposition. Thus, the deposition processes discussed herein can be advantageously used in applications such as repairs where it is expected that the material being repaired is not significantly changed during deposition.

The following listing of exemplary aspects supports and is supported by the disclosure provided herein.

Aspect 1: An apparatus for additive manufacturing, including: a modular tool positioned in a spaced apart relationship with a rotatable head holding a feed rod for additive manufacturing, the modular tool including: a first portion having a first aperture that slidably allows the feed rod to pass through, a second portion coupled with the first portion, the second portion having a second aperture aligned with the first aperture, the second aperture slidably allows the feed rod to pass through, the second portion having a melting point that is less than the melting point of the first portion, a bearing coupled with at least one of the first portion or the second portion.

Aspect 2: The apparatus of Aspect 1, wherein the second portion includes a recess, and wherein the first portion is press fit into the recess.

Aspect 3: The apparatus of any of the Aspects 1-2, wherein the second portion includes a recess and at least a portion of sidewalls of the recess are threaded, wherein at least a portion of an outer surface of the first portion is threaded, wherein the first portion is screwed into the recess.

Aspect 4: The apparatus of any of the Aspects 1-3, wherein the first portion is coupled with the second portion by clamps.

Aspect 5: The apparatus of any of the Aspects 1-4, further including a thermal barrier layer disposed between the first portion and the second portion.

Aspect 6: The apparatus of any of the Aspects 1-5, wherein the first portion is made of at least one refractory metal.

Aspect 7: The apparatus of any of the Aspects 1-6, wherein the first portion includes tungsten and rhenium.

Aspect 8: The apparatus of any of the Aspects 1-7, wherein the first aperture and the second aperture are sized such that rotation of the feed rod imparts rotational force to sidewalls of the first aperture and the second aperture.

Aspect 9: The apparatus of any of the Aspects 1-8, wherein the second portion includes a first member and a shoulder member wider than the first member, wherein the bearing is coupled with the first member, and wherein the first portion is coupled with the shoulder member of the second portion.

Aspect 10: The apparatus of any of the Aspects 1-9, wherein the second portion includes leaded steel.

Aspect 11: The apparatus of any of the Aspects 1-10, further including: a feed mechanism coupled with the rotatable head, the feed mechanism configured to move the rotatable head in relation to the modular tool.

Aspect 12: The apparatus of any of the Aspects 1-11, wherein the feed mechanism includes: a motor coupled with the feed mechanism, the movement of the motor causing the feed mechanism to move the rotatable head in relation to the modular tool, a force-sensor for sensing a force with which the feed rod extending out of the modular tool is pressed against a substrate positioned below the modular tool.

Aspect 13: The apparatus of any of the Aspects 1-12, wherein the feed rod has a rectangular cross-section, and wherein dimensions of a side of the rectangular cross-section are no more than 0.125 inches.

Aspect 14: The apparatus of any of the Aspects 1-13, wherein the feed rod has an average diameter of no more than 0.18 inches.

Aspect 15: The apparatus of any of the Aspects 1-14, further including a heat source positioned below the substrate.

Aspect 16: The apparatus of any of the Aspects 1-15, further including: a platform for moving the modular tool and the rotatable head in an x-y plane using a x-axis motor coupled with a x-axis driver and a y-axis motor coupled with a y-axis driver; a feed-axis driver coupled with the motor, which in turn is coupled with the feed mechanism; and a controller coupled with the x-axis driver, the y-axis driver, and the feed-axis driver, configured to: receive a desired feed rod position in the x-y plane, communicate with the x-axis driver and the y-axis driver to move the modular tool and the rotatable head such that a tip of the feed rod is positioned at the desired feed-rod position, receive force information from a force sensor, and communicate with the feed-axis driver to apply a constant downward force to the feed rod of a desired magnitude prior to yielding of feed-rod material.

Aspect 17: The apparatus of any of the Aspects 1-16, wherein the controller is configured to: receive temperature information from a temperature sensor sensing temperature at or around an interface between the tip of the feed-rod and the substrate, and communicating with at least one of the rotatable head and the feed-axis driver based on the received temperature and a desired temperature.

Aspect 18: The apparatus of any of the Aspects 1-17, wherein the controller is configured to: communicate with the x-axis driver and the y-axis driver to move the modular tool and the rotatable head such that the tip of the feed rod is positioned at the desired feed-rod position only after the received temperature is at the desired temperature.

Aspect 19: The apparatus of any of the Aspects 1-18, wherein the controller is configured to: communicate with the feed-axis driver to increase a downward force to the feed rod, and communicate with the x-axis driver and the y-axis driver to move the modular tool and the rotatable head over a predetermined path on the substrate.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. An apparatus for additive manufacturing, comprising:
a modular tool positioned in a spaced apart relationship with a rotatable head holding a feed rod for additive manufacturing, the modular tool comprising:
a first portion having a first aperture that slidably allows the feed rod to pass through,
a second portion coupled with the first portion, the second portion having a second aperture aligned with the first aperture, the second aperture slidably allows the feed rod to pass through, the second portion having a melting point that is less than the melting point of the first portion,
a bearing coupled with at least one of the first portion or the second portion.

2. The apparatus of claim 1, wherein the second portion includes a recess, and wherein the first portion is press fit into the recess.

3. The apparatus of claim 1, wherein the second portion includes a recess and at least a portion of sidewalls of the recess are threaded, wherein at least a portion of an outer surface of the first portion is threaded, wherein the first portion is screwed into the recess.

4. The apparatus of claim 1, wherein the first portion is coupled with the second portion by clamps.

5. The apparatus of claim 1, further comprising a thermal barrier layer disposed between the first portion and the second portion.

6. The apparatus of claim 1, wherein the first portion is made of at least one refractory metal.

7. The apparatus of claim 6, wherein the first portion includes tungsten and rhenium.

8. The apparatus of claim 1, wherein the first aperture and the second aperture are sized such that rotation of the feed rod imparts rotational force to sidewalls of the first aperture and the second aperture.

9. The apparatus of claim 1, wherein the second portion includes a first member and a shoulder member wider than the first member,
wherein the bearing is coupled with the first member, and
wherein the first portion is coupled with the shoulder member of the second portion.

10. The apparatus of claim 9, wherein the second portion includes leaded steel.

11. The apparatus of claim 1, further comprising:
a feed mechanism coupled with the rotatable head, the feed mechanism configured to move the rotatable head in relation to the modular tool.

12. The apparatus of claim 11, wherein the feed mechanism includes:
a motor coupled with the feed mechanism, the movement of the motor causing the feed mechanism to move the rotatable head in relation to the modular tool,
a force-sensor for sensing a force with which the feed rod extending out of the modular tool is pressed against a substrate positioned below the modular tool.

13. The apparatus of claim 1, wherein the feed rod has a rectangular cross-section, and wherein dimensions of a side of the rectangular cross-section are no more than 0.125 inches.

14. The apparatus of claim 1, wherein the feed rod has an average diameter of no more than 0.18 inches.

15. The apparatus of claim 12, further comprising a heat source positioned below the substrate.

16. The apparatus of claim 12, further comprising:
a platform for moving the modular tool and the rotatable head in an x-y plane using a x-axis motor coupled with a x-axis driver and a y-axis motor coupled with a y-axis driver;
a feed-axis driver coupled with the motor, which in turn is coupled with the feed mechanism; and
a controller coupled with the x-axis driver, the y-axis driver, and the feed-axis driver, configured to:
receive a desired feed rod position in the x-y plane,
communicate with the x-axis driver and the y-axis driver to move the modular tool and the rotatable head such that a tip of the feed rod is positioned at the desired feed-rod position,
receive force information from a force sensor, and
communicate with the feed-axis driver to apply a constant downward force to the feed rod of a desired magnitude prior to yielding of feed-rod material.

17. The apparatus of claim 16, wherein the controller is configured to:
receive temperature information from a temperature sensor sensing temperature at or around an interface between the tip of the feed-rod and the substrate, and
communicating with at least one of the rotatable head and the feed-axis driver based on the received temperature and a desired temperature.

18. The apparatus of claim 17, wherein the controller is configured to:
communicate with the x-axis driver and the y-axis driver to move the modular tool and the rotatable head such that the tip of the feed rod is positioned at the desired feed-rod position only after the received temperature is at the desired temperature.

19. The apparatus of claim 16, wherein the controller is configured to:
communicate with the feed-axis driver to increase a downward force to the feed rod, and
communicate with the x-axis driver and the y-axis driver to move the modular tool and the rotatable head over a predetermined path on the substrate.
